(19) United States
(12) Patent Application Publication
(10) Pub. No.: US 2026/0003541 A1
(43) Pub. Date: Jan. 1, 2026

(54) AUTOMOTIVE MEMORY DEVICE, ELECTRONIC SYSTEM INCLUDING MEMORY DEVICE, AND OPERATING METHOD OF ELECTRONIC SYSTEM

(71) Applicant: SAMSUNG ELECTRONICS CO., LTD., Suwon-si (KR)

(72) Inventor: Seungcheol Lee, Suwon-si (KR)

(21) Appl. No.: 19/054,539

(22) Filed: Feb. 14, 2025

(30) Foreign Application Priority Data
Jun. 27, 2024 (KR) 10-2024-0084650

(51) Int. Cl. G06F 3/06

(52) U.S. Cl. CPC G06F 3/0656; G06F 3/0619; G06F 3/0659; G06F 3/0679

(57) ABSTRACT

An electronic system which is mounted on a vehicle includes a first sensor device that detects first environment information of the vehicle and generates first sensor data, an integrated memory device including a CXL memory interface circuit, an integrated controller, a first volatile memory device, and a non-volatile memory device, and a host device including a CXL host interface circuit. The integrated controller reads the first sensor data from the first sensor device, stores the first sensor data in the first volatile memory device, stores the first sensor data, which is buffered in the first volatile memory device, in the non-volatile memory device, and provides the first sensor data, which is buffered in the first volatile memory device, to the host device through the CXL memory interface circuit and the CXL host interface circuit.

### CROSS-REFERENCE TO RELATED APPLICATIONS

This application claims priority under 35 U.S.C. § 119 to Korean Patent Application No. 10-2024-0084650 filed on Jun. 27, 2024, in the Korean Intellectual Property Office, the entirety of which is incorporated by reference herein.

### BACKGROUND

A semiconductor memory is classified as a volatile memory, which loses data stored therein when a power is turned off, such as a static random access memory (SRAM) or a dynamic RAM (DRAM) or a non-volatile memory, which retains data stored therein even when a power is turned off, such as a flash memory, a phase-change RAM (PRAM), a magnetic RAM (MRAM), a resistive RAM (RRAM), or a ferroelectric RAM (FRAM). The semiconductor memory is being widely used as a storage medium in various electronic devices.

As a vehicle becomes smarter and more autonomous, high-capacity, high-speed input/output, low-power, and miniaturized technologies for an automotive memory device are being actively researched. In particular, the automotive memory device needs to process a large amount of data generated by various electronic devices mounted on the vehicle.

### SUMMARY

Some aspects of the present disclosure provide automotive memory devices, electronic systems including the automotive memory devices, and operating methods of the electronic systems.

According to some implementations, an electronic system which is mounted on a vehicle includes a first sensor device that detects first environment information of the vehicle and generates first sensor data, an integrated memory device including a CXL memory interface circuit, an integrated controller, a first volatile memory device, and a non-volatile memory device, and a host device including a CXL host interface circuit, and the integrated controller that reads the first sensor data from the first sensor device, stores the first sensor data in the first volatile memory device, stores the first sensor data, which is buffered in the first volatile memory device, in the non-volatile memory device, and provides the first sensor data, which is buffered in the first volatile memory device, to the host device through the CXL memory interface circuit and the CXL host interface circuit.

According to some implementations, an operating method of an electronic system which is mounted on a vehicle and includes a first sensor device, an integrated memory device, and a host device, includes detecting, by the first sensor device, a first environment information of the vehicle, and generating a first sensor data, reading, by the integrated memory device, the first sensor data, storing, by the integrated memory device, the first sensor data in a first volatile memory device of the integrated memory device, storing, by the integrated memory device, the first sensor data, which is buffered in the first volatile memory device, in a non-volatile memory device of the integrated memory device, and providing, by the integrated memory device, the first sensor data, which is buffered in the first volatile memory device, to the host device through a CXL memory interface circuit of the integrated memory device and a CXL host interface circuit of the host device.

According to some implementations, an integrated memory device which is mounted on a vehicle and communicates with a first sensor device and a host device of the vehicle, includes a first volatile memory device, a non-volatile memory device, a CXL memory interface circuit that communicates with the host device and an integrated controller that controls the first volatile memory device and the non-volatile memory device, and the integrated controller reads first sensor data from the first sensor device, stores the first sensor data in the first volatile memory device, stores the first sensor data, which is buffered in the first volatile memory device, in the non-volatile memory device, and provides the host device with the first sensor data, which is buffered in the first volatile memory device, through the CXL memory interface circuit and a CXL host interface circuit of the host device.

### BRIEF DESCRIPTION OF THE DRAWINGS

The above and other objects and features of the present disclosure will become apparent by describing in detail examples thereof with reference to the accompanying drawings.

FIG. 1 is a diagram illustrating an example of an electronic system mounted on a vehicle.

FIG. 2 is a block diagram illustrating an example of the host device of FIG. 1.

FIG. 3 is a block diagram illustrating an example of an electronic system.

FIG. 4 is a diagram illustrating examples of data operations in the integrated memory device of FIG. 3.

FIG. 5 is a diagram illustrating an examples of a volatile memory device and an extended volatile memory device, which are connected to a host device.

FIG. 6 is a block diagram illustrating an example of the controller of FIG. 3.

FIG. 7 is a diagram illustrating an example of a process in which an integrated memory device stores sensor data in a non-volatile memory device.

FIG. 8 is a block diagram illustrating an example of an electronic system.

FIG. 9 is a diagram illustrating an example of a process in which an integrated memory device stores sensor data in a non-volatile memory device.

FIG. 10 is a flowchart illustrating an example of an operating method of an electronic system.

### DETAILED DESCRIPTION

For purposes of this disclosure, it has been recognized that, because a high-bandwidth memory device is vulnerable to heat and is difficult to be miniaturized, it is difficult to use a high-bandwidth memory device as an automotive memory device. Accordingly, a bottleneck may occur in a process where the automotive memory device stores a large amount of data and a processor of a host processes a large amount of data. This means that the overall performance of an electronic system which includes the automotive memory device is reduced. Some implementations according to this disclosure provide automotive memory devices, and associated systems and methods, that are well-suited to the automotive context and can provide improved performance.

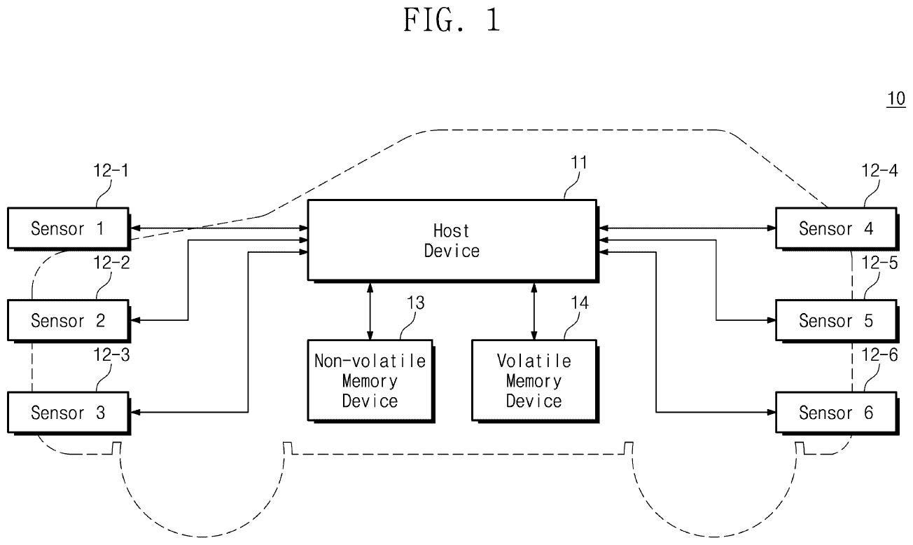

FIG. 1 is a diagram for describing a electronic system mounted on a vehicle. Referring to FIG. 1, an electronic system 10 may include a host device 11, a plurality of first to sixth sensor devices 12-1 to 12-6, a non-volatile memory device 13, and a volatile memory device 14. The host device 11 may be connected to each of the plurality of sensor devices 12-1 to 12-6, the non-volatile memory device 13, and the volatile memory device 14.

Each of the plurality of first to sixth sensor devices 12-1 to 12-6 may be mounted on the vehicle. The plurality of sensor devices 12-1 to 12-6 may sense environment information around the vehicle, and may generate first to sixth sensor data, respectively. The environment information may indicate information which may be sensed by the sensor device depending on a type of the sensor device. The sensor data may include at least one of image data, numerical data, temperature data, and sound data corresponding to the environment information.

For example, the first to third sensor devices 12-1 to 12-3 may be mounted on the front surface of the vehicle. The fourth to sixth sensor devices 12-4 to 12-6 may be mounted on the rear surface of the vehicle. And each of the plurality of first to sixth sensor devices 12-1 to 12-6 may include at least one of a camera device, a radio detection and ranging (RADAR) device, and a light detection and ranging (LiDAR) device. However, the present disclosure is not limited thereto, and the plurality of sensor devices 12-1 to 12-6 may include other types of sensor devices such as a temperature sensor, an infrared camera, and the like, and the number of sensor devices and mounting positions of the sensor devices may be different from the foregoing description.

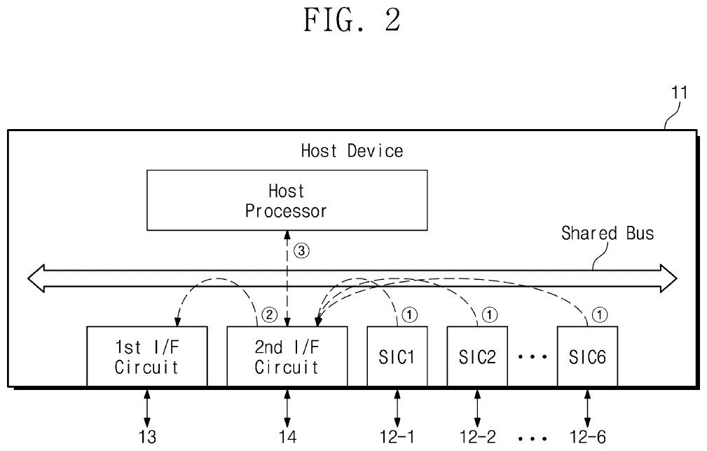

The host device 11 may read the first to sixth sensor data from the plurality of sensor devices 12-1 to 12-6. The host device 11 may store the first to sixth sensor data in the non-volatile memory device 13 or the volatile memory device 14. The host device 11 may control an autonomous drive of the vehicle by performing a signal processing operation on the first to sixth sensor data. More detailed description of the host device 11 will be provided later with reference to FIG. 2.

The host device 11 may store the first to sixth sensor data in the volatile memory device 14. This may be referred to as the host device 11 buffering the first to sixth sensor data in the volatile memory device 14.

In some implementations, the volatile memory device 14 includes at least one dynamic random access memory (DRAM) device.

The host device 11 may store the first to sixth sensor data, which are buffered in the volatile memory device 14, in the non-volatile memory device 13.

In some implementations, the non-volatile memory device 13 includes at least one NAND flash memory device. For example, the non-volatile memory device 13 may correspond to a data storage system for automated driving (DSSAD). For example, for the purpose of complying with road traffic rules and investigating accidents, the DSSAD may store a location of the vehicle, a time, a vehicle control changed by the driver, sensor data, and the like.

FIG. 2 is a block diagram for describing the host device 11 of FIG. 1. Referring to FIG. 2, the host device 11 may include a host processor, a first interface circuit, a second interface circuit, first to sixth sensor interface circuits SIC1 to SIC6, and a shared bus.

The host processor, the first interface circuit, the second interface circuit, and the first to sixth sensor interface circuits SIC1 to SIC6 may communicate with each other through the shared bus.

The host device 11 may communicate with the non-volatile memory device 13 of FIG. 1 through the first interface circuit. The host device 11 may communicate with the volatile memory device 14 of FIG. 1 through the second interface circuit. The host device 11 may communicate with the first to sixth sensor devices 12-1 to 12-6 of FIG. 1 through the first to sixth sensor interface circuits SIC1 to SIC6, respectively.

In operation \textcircled{1}, the host device 11 may store the sensor data in the non-volatile memory device 13 of FIG. 1. For example, the host device 11 may receive the first to sixth sensor data from the first to sixth sensor interface circuits SIC1 to SIC6, respectively. For example, each of the first to sixth sensor interface circuits SIC1 to SIC6 may include a camera serial interface (CSI) circuit. The host device 11 may store the first to sixth sensor data in the volatile memory device 14 through the second interface circuit. For example, the second interface circuit may include a double data rate (DDR)-based interface circuit.

In operation \textcircled{2}, the host device 11 may store the first to sixth sensor data, which are buffered in the volatile memory device 14, in the non-volatile memory device 13. For example, the host device 11 may read the first to sixth sensor data from the volatile memory device 14 through the second interface circuit. The host device 11 may provide (e.g., store) the read first to sixth sensor data to the non-volatile memory device 13 through the first interface circuit. For example, the first interface circuit may include a peripheral component interconnect express (PCIe)-based interface circuit.

In operation \textcircled{3}, the host device 11 may provide the first to sixth sensor data, which are buffered in the volatile memory device 14, to the host processor. For example, the host device 11 may read the first to sixth sensor data from the volatile memory device 14 through the second interface circuit. The host device 11 may provide the first to sixth sensor data, which are read through the shared bus, to the host processor.

The host processor may control the autonomous drive of the vehicle based on the first to sixth sensor data. The host processor may perform the signal processing operation on the first to sixth sensor data. For example, the host processor may include at least one of a neural processing unit (NPU) and a digital signal processor (DSP).

The host processor may include an internal memory device (not illustrated). For example, the host processor may include a static random access memory (SRAM) device. In the signal processing operation on the first to sixth sensor data, the host processor may use an SRAM device or the volatile memory device 14 of FIG. 1. For example, the host processor may first use the SRAM device and then use the volatile memory device 14 for a purpose similar to that of the SRAM device, based on determining that the available capacity of the SRAM device is insufficient.

Operation \textcircled{1}, operation \textcircled{2}, and operation \textcircled{3} include operations in which the host device 11 receives the first to sixth sensor data from the first to sixth sensor devices 12-1 to 12-6 through the second interface circuit, and the host device 11 transmits the first to sixth sensor data to the volatile memory device 14 and the non-volatile memory device 13 through the second interface circuit. In other words, the path of operation \textcircled{1} in which the host device 11 stores the sensor data in the volatile memory device 14, the path of operation \textcircled{2} in which the sensor data are stored in the non-volatile memory device 13, and the path of operation \textcircled{3} in which the sensor data are provided to the host processor may overlap in the second interface circuit.

Nowadays, with an advancement of an autonomous driving technology, a bandwidth of sensor data is increasing, and the number of sensor devices mounted on the vehicle is increasing, and thus a bottleneck may occur in the second interface circuit of the host device 11.

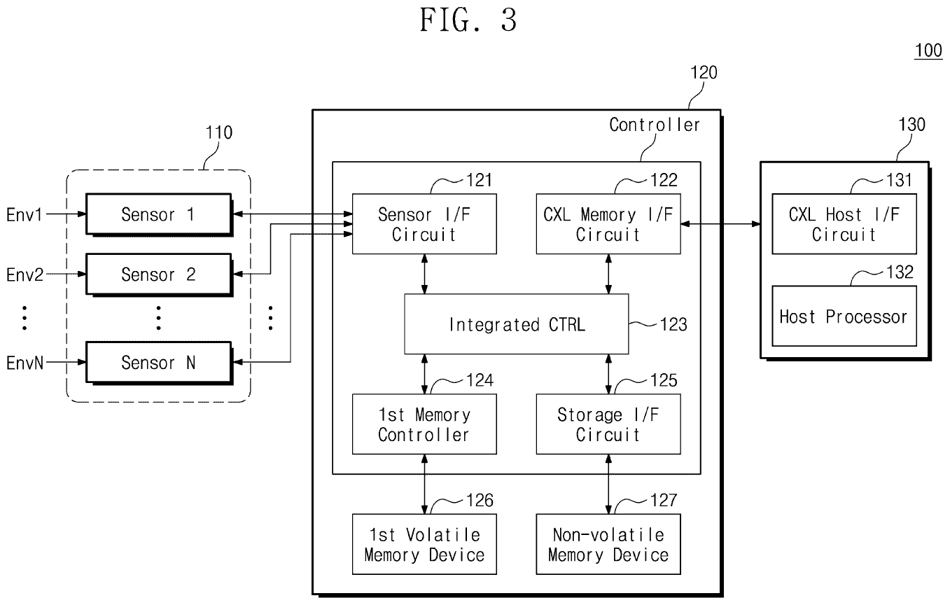

FIG. 3 is a block diagram illustrating an electronic system according to some implementations of the present disclosure. Referring to FIG. 3, an electronic system 100, which includes a sensor unit 110, an integrated memory device 120, and a host device 130, is illustrated.

The sensor unit 110 may include a first sensor device to a N-th sensor device. The first to N-th sensor devices may sense first to N-th environment information, respectively. The first to N-th sensor devices may generate first to N-th sensor data. In this case, “N” is a natural number greater than or equal to 2.

In some implementations, each of the first to N-th sensor devices includes at least one of the camera device, the RADAR device, or the LiDAR device. However, the present disclosure is not limited thereto, and the first to N-th sensor devices may instead or additionally include other types of sensor devices such as the temperature sensor and the infrared camera, and the number of sensor devices and mounting positions of the sensor devices may vary.

The integrated memory device 120 may communicate with the sensor unit 110 and the host device 130. The integrated memory device 120 may store the sensor data (e.g., at least one among the first to N-th sensor data), which are read from the sensor unit 110, and may provide the sensor data to the host device 130. The integrated memory device 120 may include a sensor interface circuit 121, a compute eXpress Link (CXL) memory interface circuit 122, an integrated controller 123, a first memory controller 124, a storage interface circuit 125, a first volatile memory device 126, and a non-volatile memory device 127.

The integrated memory device 120 may communicate with the sensor unit 110 through the sensor interface circuit 121. For example, the integrated memory device 120 may transmit a read request for the sensor data to the sensor unit 110 through the sensor interface circuit 121 under the control of the integrated controller 123, or may receive the sensor data corresponding to the read request from the sensor unit 110.

The integrated memory device 120 may communicate with the host device 130 through the CXL memory interface circuit 122. For example, the integrated memory device 120 may receive an access request, which includes data, an address, and the like, from the host device 130 through the CXL memory interface circuit 122. The integrated memory device 120 may transmit a response including data corresponding to the access request or a response indicating the completion of an operation corresponding to the access request, to the host device 130 through the CXL memory interface circuit 122.

The integrated controller 123 may control overall operations of the integrated memory device 120. For example, the integrated controller 123 may control a communication operation with each of the sensor unit 110 and the host device 130, and may control a buffering operation of the sensor data in the first volatile memory device 126, a storing operation of the sensor data in the non-volatile memory device 127, and the like.

The integrated controller 123 may read the first to N-th sensor data from the sensor unit 110. For example, the first to N-th sensor devices may store the first to N-th sensor data, respectively. The integrated controller 123 may read the first to N-th sensor data of the first to N-th sensor devices, respectively, through the sensor interface circuit 121. In some implementations, the integrated controller 123 reads the first to N-th sensor data simultaneously or sequentially. In some implementations, the integrated controller 123 periodically performs the operation of reading the sensor data from each of the first to N-th sensor devices. The period of the read operation may be determined in advance.

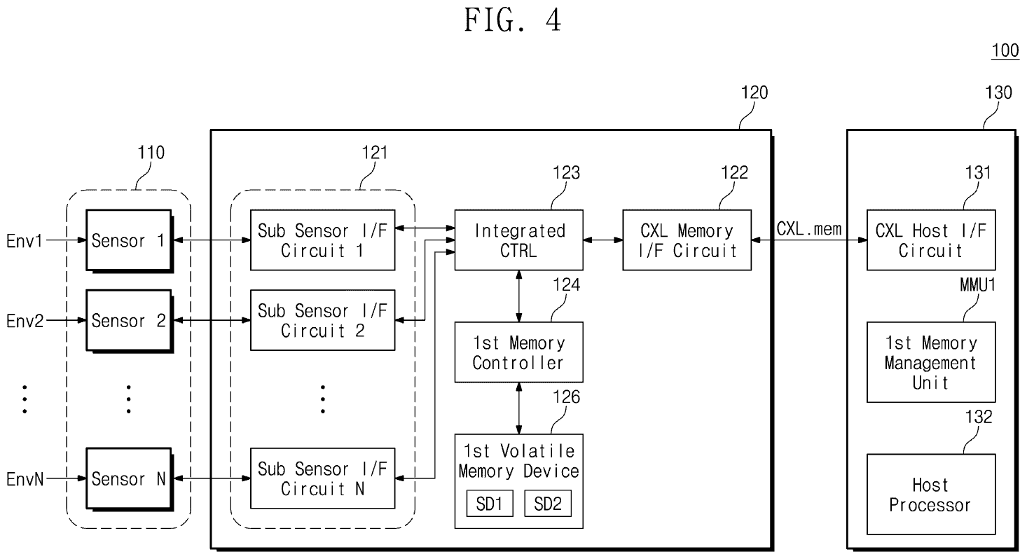

The integrated controller 123 may buffer (or store) the first to N-th sensor data, which are received from the sensor unit 110, in the first volatile memory device 126. For example, the integrated controller 123 may buffer (or store) the first to N-th sensor data in the first volatile memory device 126 through the first memory controller 124, based on at least one access request of the host device 130 and the first to N-th sensor data. In this case, the access request of the host device 130 may include physical addresses at which the first to N-th sensor data are to be stored. Each of the physical addresses may indicate a storage area of the first volatile memory device 126. A more detailed description thereof will be provided later with reference to FIG. 4.

The first memory controller 124 may be configured to store data in the first volatile memory device 126, or to read data stored from the first volatile memory device 126. In some implementations, the first volatile memory device 126 is a DRAM device, and the first memory controller 124 is implemented to comply with standard protocols such as a double data rate (DDR) interface and a low-power DDR (LPDDR) interface. However, the present disclosure is not limited to DRAM, DDR, and/or LPDDR. The first volatile memory device 126 may buffer the first to N-th sensor data in storage areas respectively corresponding to the physical addresses described above.

The integrated controller 123 may store the first to N-th sensor data, which are buffered in the first volatile memory device 126, in the non-volatile memory device 127. For example, the integrated controller 123 may read the first to N-th sensor data from the first volatile memory device 126. In some implementations, the integrated controller 123 stores information of the physical addresses for buffering the first to N-th sensor data from the host device 130 through the CXL memory interface circuit 122. The integrated controller 123 may read the first to N-th sensor data from the first volatile memory device 126 through the first memory controller 124, based on the stored information on the physical addresses.

Subsequently, the integrated controller 123 may store the read first to N-th sensor data in the non-volatile memory device 127 through the storage interface circuit 125. The storage interface circuit 125 may control the non-volatile memory device 127 to store data in the non-volatile memory device 127 or to read data from the non-volatile memory device 127. In some implementations, the storage interface circuit 125 includes at least one of various flash memory interfaces such as a toggle NAND interface or an open NAND flash interface (ONFI). For example, the non-volatile memory device 127 may include a plurality of NAND flash devices, and, when the storage interface circuit 125 is implemented based on a toggle interface, the storage interface circuit 125 communicates with the plurality of NAND flash devices through a plurality of channels. The plurality of NAND flash devices may be connected to the plurality of channels through a multi-channel multi-way structure.

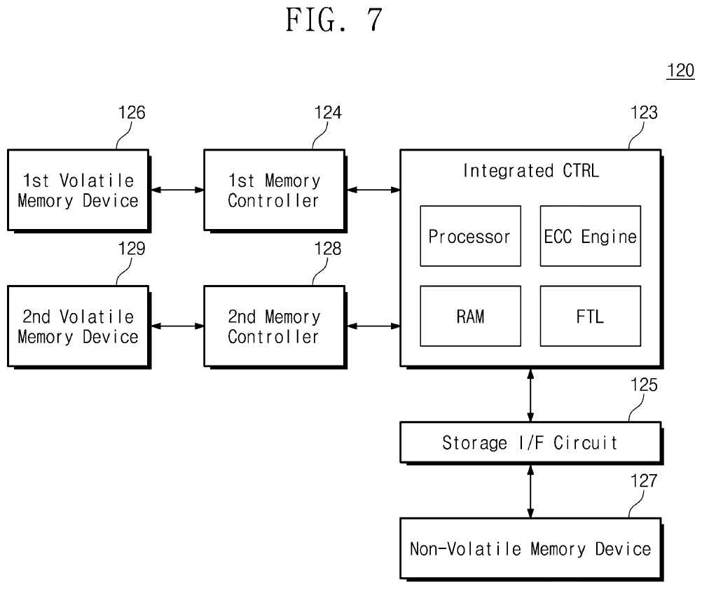

A detailed description of the operation of the integrated controller 123 storing the first to N-th sensor data, which are read from the first volatile memory device 126, in the non-volatile memory device 127 will be provided later with reference to FIG. 7.

The integrated controller 123 may provide the host device 130 with the first to N-th sensor data, which are buffered in the first volatile memory device 126, through the CXL memory interface circuit 122 and a CXL host interface circuit 131 of the host device 130.

In some implementations, the CXL memory interface circuit 122 and the CXL host interface circuit 131 may communicate based on a CXL.io protocol and a CXL.mem protocol. The CXL.io protocol may be a PCIe-based inconsistent or non-coherent input/output protocol. The CXL.mem protocol may be a memory access protocol which supports a memory access.

For example, the integrated controller 123 may provide the first to N-th sensor data to the host device 130 based on the access request received from the host device 130 through the CXL memory interface circuit 122. The access request may have a format which complies with CXL standards, such as the CXL.io protocol and the CXL.mem protocol. However, the present disclosure is not limited thereto.

The access request may include a data read request, a data write request, and the like. The access request may be a request issued by the host device 130 to access the integrated memory device 120. In this case, unless otherwise defined, the access request may be an input/output request (complying with CXL.io) or a memory access request (complying with CXL.mem). A more detailed description thereof will be provided later with reference to FIG. 4.

For example, the integrated controller 123 may read the first to N-th sensor data, which are buffered in the first volatile memory device 126, through the first memory controller 124 based on the request of the host device. The integrated controller 123 may provide the read first to N-th sensor data to the host device 130 through the CXL memory interface circuit 122.

The host device 130 may include the CXL host interface circuit 131 and a host processor 132. The host device 130 may communicate with the integrated memory device 120 through the CXL host interface circuit 131. The host processor 132 may correspond to the host processor of FIG. 2.

The host processor 132 may receive the first to N-th sensor data from the integrated memory device 120 through the CXL host interface circuit 131. The host processor 132 may perform the signal processing (or calculation), which is determined in advance as necessary for a control of the vehicle, on the first to N-th sensor data, and may generate the processed first to N-th sensor data.

The host processor 132 may include an embedded memory device. The host processor 132 may store data, calculation codes, and the like, which are required or used for the signal processing (or calculation) on the first to N-th sensor data, in the embedded memory device. For example, the embedded memory device may include the SRAM device.

In some implementations, the host processor 132 includes at least one of a central processing unit (CPU), the NPU, or the DSP. In some implementations, there are a plurality of host processors 132, and each host processor 132 may perform a given calculation.

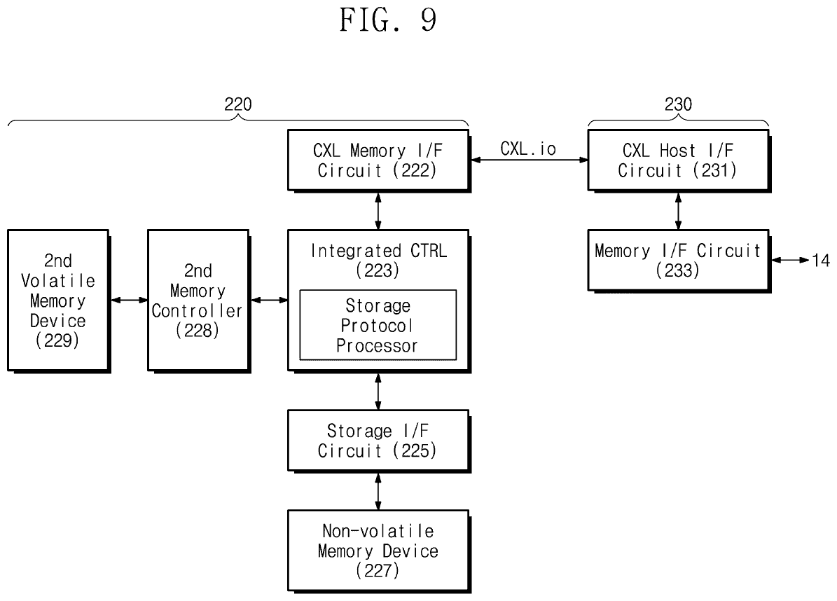

The electronic system 100 may further include at least one sensor device in addition to the first to N-th sensor devices included in the sensor unit 110. At least one sensor device may communicate with the host device 130 through a separate sensor interface circuit. A more detailed description thereof will be provided later with reference to FIG. 9.

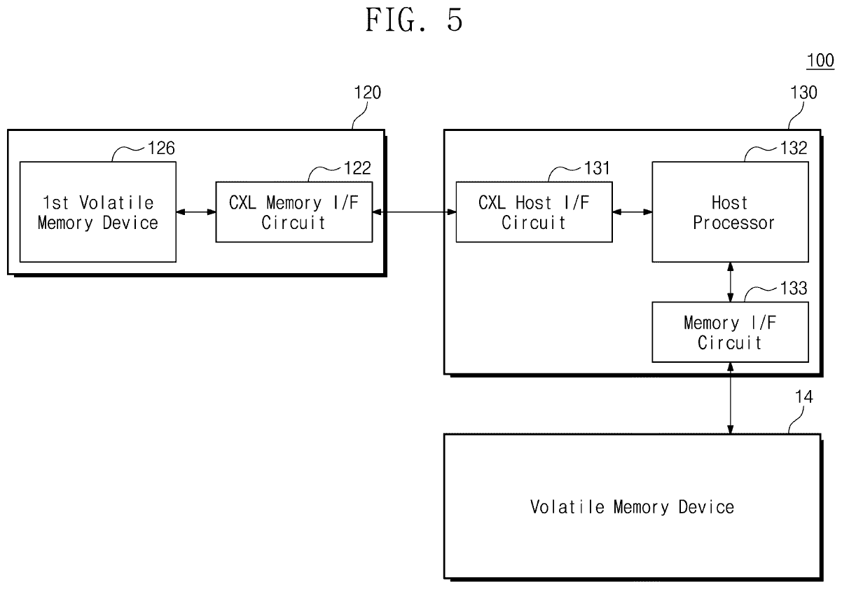

Additionally, the host device 130 may include a memory controller. The host device 130 may communicate with a volatile memory device, which is separate from the first volatile memory device 126, through the memory controller. For example, the host device 130 may communicate with a volatile memory device directly connected to the host device 130 other than the integrated memory device 120. In this case, the volatile memory device may correspond to the volatile memory device 14 of FIG. 1 and FIG. 2. For example, the volatile memory device may be the DRAM device, and the memory controller may include a DDR interface circuit. A more detailed description thereof will be provided later with reference to FIG. 5.

FIG. 4 is a diagram for illustrating data transfer for the integrated memory device 120 of FIG. 3 and the host device 130 according to some implementations of the present disclosure. Referring to FIG. 4, the electronic system 100 includes the sensor unit 110, the integrated memory device 120, and the host device 130. The sensor unit 110, the integrated memory device 120, and the host device 130, which are illustrated in FIG. 4, correspond to the sensor unit 110, the integrated memory device 120, and the host device 130 illustrated in FIG. 3, respectively.

The sensor unit 110 includes the first to N-th sensor devices. The first sensor device may detect first environment information Env1 and may generate first sensor data SD1. The second sensor device may detect second environment information Env2 and generate second sensor data SD2. Similarly, the third to N-th sensor devices may detect third to N-th environment information, respectively, and may generate third to N-th sensor data, respectively.

In some implementations, the first to N-th environment information Env1 to EnvN indicates information respectively corresponding to environments around the vehicle at the same time period.

The integrated memory device 120 may include the sensor interface circuit 121, the CXL memory interface circuit 122, the integrated controller 123, the first memory controller 124, and the first volatile memory device 126. The integrated memory device 120 may receive the first to N-th sensor data from the sensor unit 110 and may buffer the first to N-th sensor data in the first volatile memory device 126.

The host device 130 may include the CXL host interface circuit 131, the host processor 132, and a first memory management unit MMU1.

Hereinafter, an operation in which the integrated memory device 120 buffers the first to N-th sensor data in the first volatile memory device 126 will be described.

The sensor interface circuit 121 may include first to N-th sub-sensor interface circuits. In some implementations, each of the first to N-th sub-sensor interface circuits is or includes the camera serial interface (CSI) circuit.

The first to N-th sub-sensor interface circuits may receive the first to N-th sensor data from the first to N-th sensor devices, respectively. The first to N-th sub-sensor interface circuits may respectively provide the first to N-th sensor data to the integrated controller 123.

The first memory management unit MMU1 may be configured to manage for the host processor 132 to access the first volatile memory device 126. For example, the first memory management unit MMU1 may be configured to convert the logical address of data used by the host processor 132 into a memory physical address of a system memory. The first memory management unit MMU1 may issue the access request based on the memory physical address of the system memory.

The CXL host interface circuit 131 may include a CXL driver. The CXL driver may receive the access request from the first memory management unit MMU1 and may convert the received access request into a form suitable for the CXL standard. For example, the CXL driver may transmit the access request including the memory physical address to the integrated memory device 120, based on the CXL.mem protocol, which is a memory access protocol. The CXL.mem protocol may be a memory access protocol supporting a memory access in the CXL standard.

The integrated memory device 120 may operate in response to the access request (e.g., CXL.mem) including the memory physical address received from the host device 130 through the CXL memory interface circuit 122. The integrated controller 123 may access the storage area of the first volatile memory device 126 corresponding to the memory physical address in response to the access request (e.g., CXL.mem) received through the CXL memory interface circuit 122.

In some implementations, the integrated controller 123 stores (or buffers) the first to N-th sensor data in memory areas corresponding to memory physical addresses, in response to at least one access request (e.g., CXL.mem).

For example, the integrated controller 123 may receive the first sensor data SD1 from the first sensor device through the first sub-sensor interface circuit, and may receive the first memory physical address from the host device 130 through the CXL memory interface circuit 122. The integrated controller 123 may store the first sensor data SD1 in the first volatile memory device 126, based on the first sensor data SD1 and the first memory physical address.

In some implementations, the integrated controller 123 receives the second sensor data SD2 from the second sensor device through the second sub-sensor interface circuit, and receives the second memory physical address from the host device 130 through the CXL memory interface circuit 122. The integrated controller 123 may store the second sensor data SD2 in the first volatile memory device 126, based on the second sensor data SD2 and the second memory physical address.

For convenience of description, only the first sensor data SD1 and the second sensor data SD2 are described, but the third to N-th sensor data may also be stored in the first volatile memory device 126 through similar operations. Additionally, the first memory physical address for storing the first sensor data SD1 and the second memory physical address for storing the second sensor data SD2 may be included in one access request or may be included in different access requests.

Hereinafter, an operation in which the integrated memory device 120 provides the first to N-th sensor data to the host device 130 will be mainly described.

The host device 130 may receive a response to at least one access request, which indicate storage of the first sensor data SD1 and the second sensor data SD2, from the integrated memory device 120.

The host device 130 may transmit at least one access request (e.g., CXL.mem), which indicates a read of the first sensor data SD1 and the second sensor data SD2, to the integrated memory device 120, based on the response. At least one access request (e.g., CXL.mem) indicating the read of the first sensor data SD1 and the second sensor data SD2 may include the first memory physical address and the second memory physical address. In this case, the integrated controller 123 may read the first sensor data SD1 and the second sensor data SD2, which are stored in the memory area of the first volatile memory device 126 corresponding to the first memory physical address and the second memory physical address, based on the access request (i.e., CXL.mem).

The integrated controller 123 may provide the first sensor data SD1 and the second sensor data SD2, which are read, to the host device 130 through the CXL memory interface circuit 122 in response to the read access request.

The host processor 132 may perform signal processing (or calculation) on the first sensor data SD1 and the second sensor data SD2, which are received through the CXL host interface circuit 131.

As described above, the first memory management unit MMU1 of the host device 130 may manage a system memory area. In this case, the host device 130 may recognize the first volatile memory device 126 of the integrated memory device 120 as the system memory area. The first memory management unit MMU1 may use the storage area of the first volatile memory device 126 as the system memory area, and may access the first volatile memory device 126, based on the memory access request (e.g., CXL.mem).

FIG. 5 is a diagram for describing a volatile memory device 14 and an extended volatile memory device 126, which are connected to a host device, according to some implementations of the present disclosure. Referring to FIG. 5, the host device 130 communicating with the volatile memory device 14 and the integrated memory device 120 is illustrated. The volatile memory device 14 of FIG. 5 corresponds to the volatile memory device 14 of FIG. 1, and the host device 130 and the integrated memory device 120 of FIG. 5 correspond to the host device 130 and the memory device 120 of FIG. 3, respectively.

Like the electronic system 10 of FIG. 1, the host device 130 may communicate with a system memory such as the volatile memory device 14. The host device 130 may further include a memory interface circuit 133. The host device 130 may store data in the volatile memory device 14 or may read data from the volatile memory device 14 through the memory interface circuit 133.

In some implementations, the memory interface circuit 133 complies with a DDR standard protocol. The volatile memory device 14 may be a DRAM device.

The host device 130 may communicate with the integrated memory device 120 through the CXL memory interface circuit 122 and the CXL host interface circuit 131. The integrated memory device 120 may include the CXL memory interface circuit 122 and the first volatile memory device 126. In this case, the CXL memory interface circuit 122 and the first volatile memory device 126 of FIG. 5 correspond to the CXL memory interface circuit 122 and the first volatile memory device 126 of FIG. 3, and the CXL memory interface circuit 122 and the first volatile memory device 126 may communicate indirectly through the integrated controller 123 of FIG. 3.

As described above, the host device 130 may not only include the volatile memory device 14 as the system memory included in the electronic system 10 of FIG. 1, but may also recognize the integrated memory device 120 (e.g., the first volatile memory device 126) communicating based on the CXL standard protocol, as an extended system memory.

Therefore, the electronic system which uses the integrated memory device 120 may provide the host device 130 with the extended volatile memory device (e.g., the first volatile memory device 126).

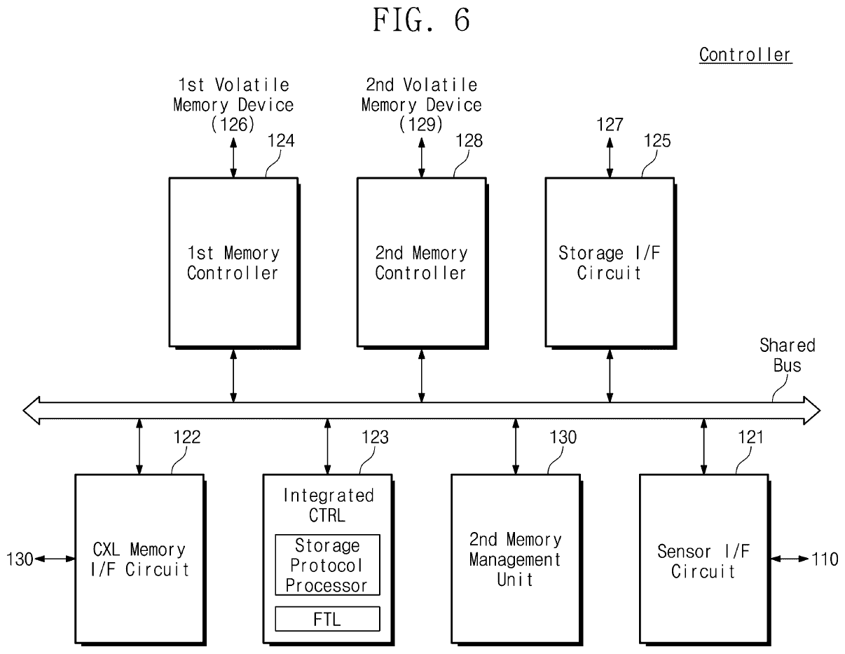

FIG. 6 is a block diagram illustrating a controller of FIG. 3 in detail. Referring to FIG. 6, the controller, which includes the sensor interface circuit 121, the CXL memory interface circuit 122, the integrated controller 123, the first memory controller 124, the storage interface circuit 125, a second memory controller 128, and a second memory management unit MMU2, is illustrated. The components in FIG. 6 correspond to the components having the same reference numbers in FIG. 3, respectively.

The sensor interface circuit 121, the CXL memory interface circuit 122, the integrated controller 123, the first memory controller 124, the storage interface circuit 125, the second memory controller 128, and the second memory management unit MMU2 may be configured to communicate with each other through a shared bus, as illustrated in FIG. 6.

The sensor interface circuit 121 may communicate with the sensor unit 110 of FIG. 3. The CXL memory interface circuit 122 may communicate with the host device 130 of FIG. 3. The first memory controller 124 may store data in the first volatile memory device 126 of FIG. 3 or may read data from the first volatile memory device 126. The storage interface circuit 125 may store data in the non-volatile memory device 127 of FIG. 3 or may read data from the non-volatile memory device 127.

The integrated memory device of FIG. 3 may further include the second memory controller 128 and a second volatile memory device 129. The second memory controller 128 may be included in the controller. The second memory controller 128 may store data in the second volatile memory device 129 or may read data from the second volatile memory device 129 under the control of the integrated controller 123.

The second volatile memory device 129 may store information which is used when the integrated controller 123 stores data in the non-volatile memory device 127 or reads data from the non-volatile memory device 127. For example, the second volatile memory device 129 may be configured to store map data (or a mapping table) used by a flash translation layer (FTL), information necessary or used for the operation of the integrated controller 123 associated with the non-volatile memory device 127, and the like.

In some implementations, the second volatile memory device 129 is or includes a buffer memory configured to temporarily store data read from the non-volatile memory device 127.

The second memory management unit MMU2 may be configured to manage operations for the integrated controller 123 to access the second volatile memory device 129. For example, the second memory management unit MMU2 may be configured to convert a logical address, which is used when the integrated controller 123 manages the second volatile memory device 129, into a memory physical address.

The integrated controller 123 may read the map data from the second volatile memory device 129, based on the memory physical address converted through the second memory management unit MMU2. The integrated controller 123 may store the sensor data in the non-volatile memory device 127, based on the map data read from the second volatile memory device 129 and the sensor data read from the first volatile memory device 126. A more detailed description thereof will be provided later with reference to FIG. 7.

The integrated controller 123 may include a storage protocol processor and the FTL. The storage protocol processor may convert an access request (e.g., CXL.io), which is received from the host device 130, into a storage access request complying with a storage protocol, with which the storage interface circuit 125 complies. The storage protocol processor may be implemented by a combination of software and hardware, firmware, and any combination thereof, but the present disclosure is not limited thereto. In some implementations, the storage protocol includes a PCIe-based protocol.

The FTL may convert a logical address, which is used when the integrated controller 123 manages the non-volatile memory device 127, into a physical address, based on the map data read from the second volatile memory device 129. In this case, the logical address and the physical address may be managed in association with the non-volatile memory device 127. These logical address and physical address may be different from the logical address and the physical address which are managed by the first memory management unit MMU1.

In addition, the FTL may perform various management operations for efficiently using the non-volatile memory device 127. For example, the FTL may perform a bad block management operation for the non-volatile memory device 127. The FTL may perform a wear leveling operation for the non-volatile memory device 127. The FTL may perform a garbage collection operation for the non-volatile memory device 127.

In some implementations, the FTL is implemented based on software, hardware, firmware, or a combination thereof. A more detailed description of the FTL will be provided later with reference to FIG. 7.

As such, the controller in the integrated memory device 120 of FIG. 3 may provide an extended volatile memory device which receives sensor data through the sensor interface circuit 121 and stores the sensor data in the first volatile memory device 126. In addition, the sensor data buffered in the first volatile memory device 126 may be stored in the non-volatile memory device 127 without going through the host device 130, e.g., through connections that bypass the host device 130. In addition, sensor data received from sensor devices directly connected to the host device 130 may also be stored in the non-volatile memory device 127, by using the CXL memory interface circuit 122, the integrated controller 123, and the second volatile memory device 129.

FIG. 7 is a diagram illustrating storage of sensor data by the integrated memory device 120 in the non-volatile memory device 127, according to some implementations of the present disclosure. In this case, the sensor data refers to sensor data generated by sensor devices (e.g., sensor devices included in the sensor unit 110 of FIG. 3) directly connected to the integrated memory device 120.

The integrated controller 123 may have information on the memory physical addresses at which the first to N-th sensor data are stored. The memory physical address may indicate the physical address associated with the first volatile memory device 126 of FIG. 3. The integrated controller 123 may read the first to N-th sensor data from the first volatile memory device 126 through the first memory controller 124 in response to the first to N-th sensor data being stored in the first volatile memory device 126, based on the stored physical addresses.

In response to the first to N-th sensor data being read from the first volatile memory device 126, the integrated controller 123 may allocate logical addresses to the first to N-th sensor data, respectively. The FTL of the integrated controller 123 may convert the logical addresses respectively allocated to the first to N-th sensor data into physical addresses associated with the non-volatile memory device 127. For example, the FTL may refer to the map data read from the second volatile memory device 129. The integrated controller 123 may allocate the physical addresses to the first to N-th sensor data, respectively.

The integrated controller 123 may further include the FTL, a processor, an error correction code (ECC) engine, and a RAM.

The FTL of the integrated controller 123 may convert the above-described logical address into the physical address associated with the non-volatile memory device 127 based on the map data.

The ECC engine may perform error detection and correction on data stored in the non-volatile memory device 127. For example, the ECC engine may generate parity bits for the data stored in the non-volatile memory device 127, and the generated parity bits may be stored in the non-volatile memory device 127 together with the data. When the data is read from the non-volatile memory device 127, an error in the data may be detected and corrected by using the parity bits read from the non-volatile memory device 127 together with the read data.

The RAM may be configured to control overall operations of the integrated controller 123 controlling the non-volatile memory device 127. The RAM may be used as an operating memory or a buffer memory of the integrated controller 123. In some implementations, the RAM is a static random access memory (SRAM), and may be used as a read buffer or a write buffer for the non-volatile memory device 127. In some implementations, the RAM is configured to temporarily store the map data or a part of the map data read from the second volatile memory device 129.

In some implementations, when the FTL is implemented in a software form or a firmware form, program codes related to the FTL may be stored in a RAM associated with the non-volatile memory device 127 in the integrated controller 123, and may be driven by a processor associated with the non-volatile memory device 127 in the integrated controller 123. When the FTL is implemented in hardware, the hardware components configured to perform the various management operations described above may be implemented in the integrated controller 123.

The integrated controller 123 may store the sensor data in the non-volatile memory device 127 through the storage interface circuit 125, based on the at least one physical address converted by the FTL and the read sensor data.

In some implementations, the non-volatile memory device 127 is detachable from the integrated memory device 120. For example, the non-volatile memory device 127 may be used as a data storage system for automated driving (DSSAD) for a vehicle having an autonomous driving function.

In some implementations, the integrated memory device 120 provides information, which indicates that the sensor data is stored in a storage area in the non-volatile memory device 127 corresponding to the physical address, to the host device 130 of FIG. 3.

Accordingly, the integrated memory device 120 may store sensor data, which is received from sensor devices (e.g., the sensor unit 110 of FIG. 3) directly connected to the integrated memory device 120, in the non-volatile memory device 127 without going through the host device, e.g., through connections that bypass the host device.

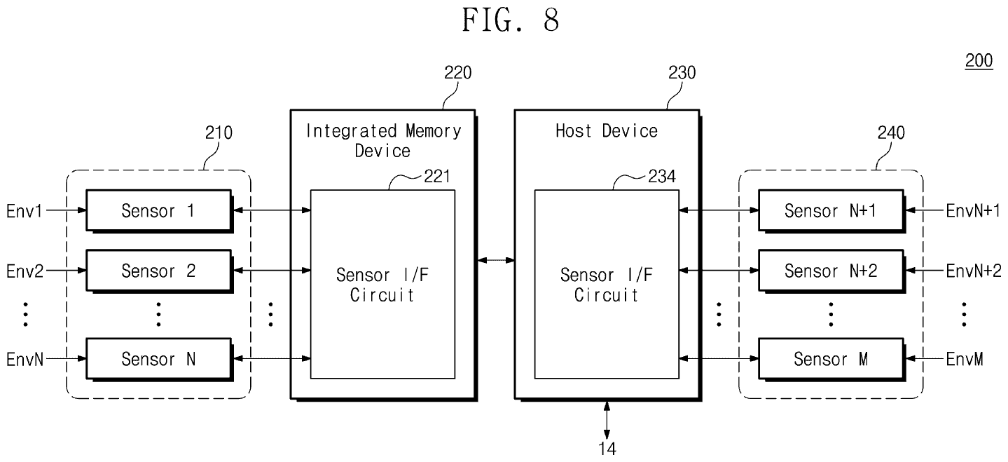

FIG. 8 is a block diagram illustrating an electronic system 200 according to some implementations of the present disclosure. Referring to FIG. 8, the electronic system 200, which includes a first sensor unit 210, an integrated memory device 220, a host device 230, and a second sensor unit 240, is illustrated. The first sensor unit 210, the integrated memory device 220, and the host device 230 correspond to the sensor unit 110, the integrated memory device 120, and the host device 130 of FIG. 3, respectively.

The electronic system 200 mounted on the vehicle may include a first sensor device to a M-th sensor device. “M” is a natural number greater than “N”. The first to N-th sensor devices may be referred to as “one sensor unit” (e.g., the first sensor unit 210), and the (N+1)-th to M-th sensor devices may be referred to as “another sensor unit” (e.g., the second sensor unit 240).

The first sensor unit 210 may include the first to N-th sensor devices. The first to N-th sensor devices may sense the first to N-th environment information Env1 to EnvN, respectively, and may generate the first to N-th sensor data, respectively. Because the description of the first sensor unit 210 is provided above, a detailed description thereof will be omitted below.

The first to N-th sensor devices of the first sensor unit 210 are directly connected to the integrated memory device 120. For example, the integrated memory device 120 may directly communicate with the first to N-th sensor devices through a sensor interface circuit 221.

The second sensor unit 240 may include the (N+1)-th to M-th sensor devices. The (N+1)-th sensor device may detect (N+1)-th environment information EnvN+1 and may generate (N+1)-th sensor data. The (N+2)-th sensor device may detect (N+2)-th environment information EnvN+2 and may generate (N+2)-th sensor data. In addition, the M-th sensor device may detect M-th environment information EnvM and may generate M-th sensor data. Although not illustrated, (N+3)-th to (M-1)-th sensor devices may operate similarly thereto.

In some implementations, at least one of a camera device, a RADAR device, or a LiDAR device of (N+1)-th to M-th sensor devices may be included. However, the present disclosure is not limited thereto, and the (N+1)-th to M-th sensor devices may include other types of sensor devices such as the temperature sensor and the infrared camera, and the number of the sensor devices and mounting positions of the sensor devices may vary.

The host device 230 is directly connected to the (N+1)-th to M-th sensor devices. The host device 230 may communicate with each of the (N+1)-th to M-th sensor devices of the second sensor unit 240 through a sensor interface circuit 234. The sensor interface circuit 234 may be included in the host device 230. In some implementations, the sensor interface circuit 234 includes the CSI circuit.

The host device 230 may read (N+1)-th to M-th sensor data from the second sensor unit 240 through the sensor interface circuit 234. The host device 230 may buffer (or store) the (N+1)-th to M-th sensor data in the volatile memory device 14. The volatile memory device 14 may correspond to the volatile memory device 14 of FIG. 1 and FIG. 2.

For example, the host device 230 may include the first memory management unit MMU1 of FIG. 4. The first memory management unit MMU1 may manage access to the volatile memory device 14 of the host device 230. The first memory management unit MMU1 may generate a memory physical address corresponding to a memory area of the volatile memory device 14 storing the (N+1)-th to M-th sensor data. The host device 230 may store the (N+1)-th to M-th sensor data in the volatile memory device 14 based on the memory physical address.

Accordingly, the electronic system 200 may divide and connect “M” sensor devices mounted on the vehicle to the integrated memory device 220 and the host device 230. Accordingly, the bandwidth of the sensor data, which is transmitted and received by the host device 230 at once, may be adjusted. The number of sensor devices directly connected to the integrated memory device 220 may be adjusted in consideration of the bandwidth of each of the “M” sensor devices, the bandwidth of the memory interface circuit of the host device 230, and the like. Accordingly, bottlenecks which may occur in interface circuits in the electronic system 200 may be reduced in the electronic system 200, and the performance of the electronic system 200 may be improved.

FIG. 9 is a diagram illustrating storage of sensor data by the integrated memory device 220 in a non-volatile memory device 227, according to some implementations of the present disclosure. Referring to FIG. 9, the integrated memory device 220 and the host device 230 are illustrated. In this case, the sensor data may refer to the sensor data generated by the sensor devices (e.g., the N+1 to M-th sensor devices in FIG. 8) directly connected to the host device 230.

The host device 230 may include a CXL host interface circuit 231 and a memory interface circuit 233. The CXL host interface circuit 231 and the memory interface circuit 233 correspond to the CXL host interface circuit 131 and the memory interface circuit 133 of FIG. 5, respectively.

As described above, the volatile memory device 14 of FIG. 6 may buffer the (N+1)-th to M-th sensor data. The (N+1)-th to M-th sensor data may be generated by the (N+1)-th to M-th sensor devices of FIG. 8, respectively.

The host device 230 may read the (N+1)-th to M-th sensor data from the volatile memory device 14. For example, the host device 230 may obtain physical addresses, which correspond to a storage area in which the (N+1)-th to M-th sensor data are stored in the volatile memory device 14, through the first memory management unit MMU1 of FIG. 6. The host device 230 may read the (N+1)-th to M-th sensor data from the volatile memory device 14, based on the obtained physical address.

The host device 230 may provide an access request (e.g., CXL.io), which indicates storage of the read (N+1)-th to M-th sensor data, to the integrated memory device 220 through the CXL host interface circuit 231. For example, the access request (i.e., CXL.io) may include the (N+1)-th to M-th sensor data.

The integrated memory device 220 may include a CXL memory interface circuit 222, an integrated controller 223, a storage interface circuit 225, the non-volatile memory device 227, a second memory controller 228, and a second volatile memory device 229.

The integrated controller 223 may receive the access request (e.g., CXL.io) from the host device 230 through the CXL memory interface circuit 222. The storage protocol processor in the integrated controller 223 may convert the access request (e.g., CXL.io) into a storage access request complying with the protocol of the storage interface circuit 225. The storage access request may include the (N+1)-th to M-th sensor data.

In some implementations, the integrated controller 223 buffers the (N+1)-th to M-th sensor data in the second volatile memory device 229 through the second memory controller 228. The integrated controller 223 may read map data corresponding to a storage area of the non-volatile memory device 227 to store the (N+1)-th to M-th sensor data through the second memory controller 228. The integrated controller 223 may store the (N+1)-th to M-th sensor data in the non-volatile memory device 227, based on the read map data.

For example, the integrated controller 223 may allocate at least one physical address associated with the non-volatile memory device 227 to the (N+1)-th to M-th sensor data. For example, in managing the non-volatile memory device 227, the integrated controller 223 may generate at least one logical address corresponding to the (N+1)-th to M-th sensor data. The FTL of FIG. 7 in the integrated controller 223 may convert at least one logical address into at least one physical address, based on the map data read from the second volatile memory device 229. The integrated controller 223 may store the (N+1)-th to M-th sensor data in a storage area in the non-volatile memory device 227 corresponding to the at least one physical address.

In some implementations, the integrated memory device 220 may provide the host device 230 with a response indicating that the (N+1)-th to M-th sensor data are stored in the non-volatile memory device 227.

As such, the integrated memory device 220 may store sensor data (e.g., all the sensor data), which are generated from the sensor devices directly connected to the integrated memory device 220 as well as the sensor data generated from the sensor devices directly connected to the host device 230, in the non-volatile memory device 227. Accordingly, the non-volatile memory device 227 may store the sensor data generated from various sensor devices mounted on the vehicle regardless of the interconnections of the sensor devices, e.g., all the sensor devices mounted on the vehicle.

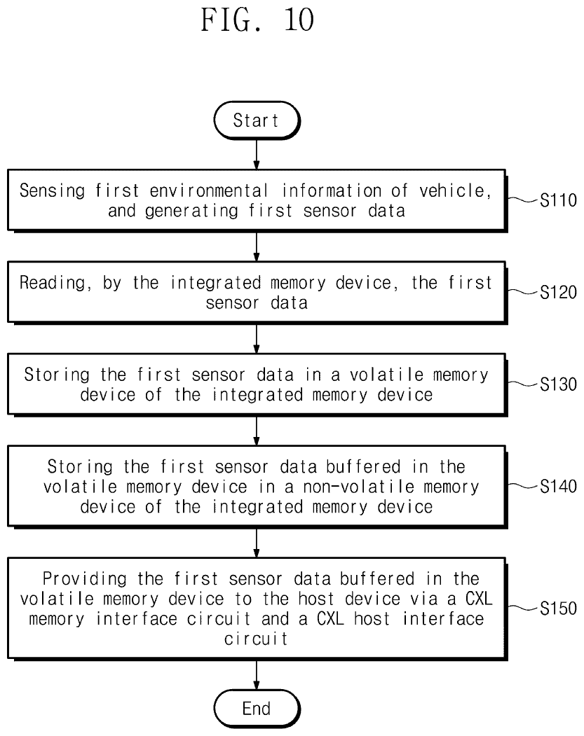

FIG. 10 is a flowchart illustrating an example of an operating method of an electronic system (e.g., the electronic system 100 of FIG. 3 or the electronic system 200 of FIG. 8) according to some implementations of the present disclosure. Referring to FIG. 10, an operating method of an electronic system, which includes a sensor device, an integrated memory device, and a host device, and is mounted on a vehicle, will be described. The electronic system of FIG. 10 can correspond, for example, to the electronic system 100 of FIG. 3 or the electronic system 200 of FIG. 8. The integrated memory device may include a CXL memory interface circuit, a sensor interface circuit, an integrated controller, a first volatile memory device, and a non-volatile memory device.

Although some operations of FIG. 10 are described as being performed by particular element(s) (e.g., an integrated controller), it will be understood that the operating method is not limited to these examples and that the disclosed operations can be performed using various one or more elements, devices, circuits, and/or the like.

In operation S110, the electronic system detects first environment information by a first sensor device and generates first sensor data.

In some implementations, the first sensor device includes at least one of a camera device, a RADAR device, or a LiDAR device. However, the present disclosure is not limited thereto, and the first sensor device may include other types of sensor devices such as a temperature sensor and/or an infrared camera.

In operation S120, the electronic system reads the first sensor data by or using the integrated controller of the integrated memory device.

In some implementations, the integrated controller receives the first sensor data from the first sensor device through the sensor interface circuit. For example, the sensor interface circuit may include a CSI circuit.

In some implementations, the electronic system reads the first sensor data at determined intervals in advance.

In operation S130, the electronic system buffers the first sensor data in the first volatile memory device by or using the integrated controller of the integrated memory device.

In operation S140, the electronic system stores, by or using the integrated controller of the integrated memory device, the first sensor data buffered in the first volatile memory device, in the non-volatile memory device.

In some implementations, operation S140 includes reading the first sensor data from the first volatile memory device in response to or based on the first sensor data being stored in the first volatile memory device (e.g., by the integrated controller), allocating a first physical address associated with the non-volatile memory device to the first sensor data (e.g., by the integrated controller), and storing the first sensor data in a storage area in the non-volatile memory device corresponding to the first physical address (e.g., by the integrated controller).

In operation S150, the electronic system provides the first sensor data buffered in the first volatile memory device to the host device through the CXL memory interface circuit and the CXL host interface circuit of the host device, by or using the integrated controller of the integrated memory device.

In some implementations, the CXL memory interface circuit and the CXL host interface circuit may communicate based on the CXL.io protocol, which is a PCIe-based inconsistent input/output protocol, and the CXL.mem protocol, a memory access protocol supporting memory access.

In some implementations, the electronic system includes a second sensor device, and the operating method of the electronic system described above may further include sensing second environment information of the vehicle by the second sensor device, generating second sensor data by the second sensor device, reading the second sensor data from the second sensor device (e.g., by the host device), and storing the second sensor data in the integrated memory device (e.g., by the host device) through the CXL host interface circuit and the CXL memory interface circuit. Furthermore, the operating method of the electronic system may further include allocating a second physical address associated with the non-volatile memory device to the second sensor data (e.g., by the integrated controller), and storing the second sensor data in a storage area in the non-volatile memory device corresponding to the second physical address (e.g., by the integrated controller).

The foregoing methods can correspond, for example, to a memory device for a vehicle, and/or an electronic system including the memory device.

As such, based on the foregoing description, a large amount of sensor data may be received by a host device and a vehicle memory device separately, and the overlap between a path for buffering the sensor data in a volatile memory device, a path for providing the sensor data to a host processor, and a path for storing the sensor data in a non-volatile memory device is reduced, such that the performance of an electronic system mounted on a vehicle is improved.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above-described contents include specific examples for carrying out the present disclosure. The present disclosure will be understood to include not only the above-described examples, but also implementations based on the foregoing examples, e.g., based on modifying the examples. It will be apparent to those of ordinary skill in the art that various changes and modifications may be made to the described examples and implementations without departing from the spirit and scope of the present disclosure.

What is claimed is:

1. An electronic system configured to be mounted at a vehicle, comprising:
a first sensor device configured to detect first environmental information of the vehicle and to generate first sensor data based on the first environmental information;
an integrated memory device including a compute express link (CXL) memory interface circuit, an integrated controller, a first volatile memory device, and a non-volatile memory device; and
a host device including a CXL host interface circuit,
wherein the integrated controller is configured to:
obtain the first sensor data from the first sensor device,
store the first sensor data in the first volatile memory device as buffered first sensor data,
store the buffered first sensor data in the non-volatile memory device, and
provide the buffered first sensor data to the host device through the CXL memory interface circuit and the CXL host interface circuit.

2. The electronic system of claim 1, wherein the CXL memory interface circuit and the CXL host interface circuit are configured to communicate based on a peripheral component interconnect express (PCIe)-based non-coherent input/output protocol, and based on a memory access protocol supporting memory access.

3. The electronic system of claim 1, further comprising second to M-th sensor devices, wherein the second to M-th sensor devices are configured to:
detect second to M-th environmental information of the vehicle, respectively; and
generate second to M-th sensor data, respectively, based on the second to M-th environmental information, and
wherein the integrated controller is further configured to:
obtain the second to N-th sensor data, among the second to M-th sensor data, from the second to N-th sensor devices, among the second to M-th sensor devices, respectively, wherein “N” is a natural number greater than 2, and “M” is a natural number greater than “N”;
store the second to N-th sensor data in the first volatile memory device as buffered second to N-th sensor data;
store the buffered second to N-th sensor data in the non-volatile memory device; and
provide the buffered second to N-th sensor data to the host device through the CXL memory interface circuit and the CXL host interface circuit.

4. The electronic system of claim 3, wherein each of the first to M-th sensor devices includes at least one of a radio detection and ranging (RADAR) device, a light detection and ranging (LiDAR) device, or a camera.

5. The electronic system of claim 3, further comprising a second volatile memory device configured to communicate with the host device through a memory interface circuit,
wherein the host device is configured to:
obtain the (N+1)-th to M-th sensor data, among the second to M-th sensor data, from the (N+1)-th to M-th sensor devices. among the second to M-th sensor devices; and
store the (N+1)-th to M-th sensor data in the second volatile memory device.

6. The electronic system of claim 5, wherein the memory interface circuit is based on a double data rate (DDR) protocol, and
wherein the second volatile memory device is a dynamic random access memory (DRAM).

7. The electronic system of claim 5, wherein the integrated controller includes a non-volatile memory express (NVMe) protocol processor, and
wherein the NVMe protocol processor is configured to:
receive at least one access request from the host device through the CXL memory interface circuit, the at least one access request corresponding to the (N+1)-th to M-th sensor data; and
convert the at least one access request into at least one storage access request complying with a storage protocol that supports access to the non-volatile memory device,
wherein the integrated controller is configured to store the (N+1)-th to M-th sensor data in the non-volatile memory device based on the at least one storage access request.

8. The electronic system of claim 7, wherein the storage protocol is based on a protocol that complies with a PCIe standard.

9. The electronic system of claim 1, wherein the integrated controller is further configured to:
read, as read first sensor data, the buffered first sensor data from the first volatile memory device in response to the first sensor data being stored in the first volatile memory device;
allocate a first physical address to the read first sensor data, the first physical address being associated with the non-volatile memory device; and
store the read first sensor data in a storage area of the non-volatile memory device corresponding to the first physical address.

10. The electronic system of claim 1, wherein the non-volatile memory device is detachable from other components of the integrated memory device.

11. The electronic system of claim 1, wherein the integrated memory device is configured to receive the first sensor data through a camera serial interface (CSI) circuit.

12. An operating method of an electronic system configured to be mounted at a vehicle, the electronic system including a first sensor device, an integrated memory device, and a host device, the method comprising:
detecting, by the first sensor device, first environmental information of the vehicle, and generating, by the first sensor device, first sensor data based on the first environmental information;
obtaining, by the integrated memory device, the first sensor data from the first sensor device;
storing, by the integrated memory device, the first sensor data in a first volatile memory device of the integrated memory device, as buffered first sensor data;
storing, by the integrated memory device, the buffered first sensor data in a non-volatile memory device of the integrated memory device; and
providing, by the integrated memory device, the buffered first sensor data to the host device through a compute express link (CXL) memory interface circuit of the integrated memory device and a CXL host interface circuit of the host device.

13. The method of claim 12, wherein the CXL memory interface circuit and the CXL host interface circuit are configured to communicate based on a peripheral component interconnect express (PCIe)-based non-coherent input/output protocol, and based on a memory access protocol supporting memory access.

14. The method of claim 12, wherein storing the first sensor data in the non-volatile memory device of the integrated memory device comprises:
reading, by an integrated controller of the integrated memory device, as read first sensor data, the buffered first sensor data from the first volatile memory device in response to the first sensor data being stored in the first volatile memory device;
allocating, by the integrated controller, a first physical address associated with the non-volatile memory device to the read first sensor data; and
storing, by the integrated controller, the read first sensor data in a storage area of the non-volatile memory device corresponding to the first physical address.

15. The method of claim 12, wherein the electronic system further includes a second sensor device, and
wherein the method further comprises:
detecting, by the second sensor device, second environmental information of the vehicle;
generating, by the second sensor device, second sensor data based on the second environmental information;
obtaining, by the host device, the second sensor data; and
providing, by the host device, the second sensor data to the integrated memory device through the CXL host interface circuit and the CXL memory interface circuit.

16. The method of claim 15, further comprising:
allocating, by an integrated controller of the integrated memory device, a second physical address to the second sensor data, the second physical address being associated with the non-volatile memory device; and
storing, by the integrated controller, the second sensor data in a storage area of the non-volatile memory device corresponding to the second physical address.

17. An integrated memory device configured to be mounted at a vehicle and configured to communicate with a first sensor device and a host device of the vehicle, the integrated memory device comprising:
a first volatile memory device;
a non-volatile memory device;
a compute express link (CXL) memory interface circuit configured to communicate with the host device; and
an integrated controller configured to control the first volatile memory device and the non-volatile memory device,
wherein the integrated controller is configured to:
obtain first sensor data from the first sensor device,
store the first sensor data in the first volatile memory device as buffered first sensor data,
store the buffered first sensor data in the non-volatile memory device; and
provide the host device with the buffered first sensor data through the CXL memory interface circuit and a CXL host interface circuit of the host device.

18. The integrated memory device of claim 17, wherein the CXL memory interface circuit and the CXL host interface circuit are configured to communicate based on a peripheral component interconnect express (PCIe)-based non-coherent input/output protocol, and based on a memory access protocol supporting a memory access.

19. The integrated memory device of claim 17, wherein the integrated controller is further configured to:
read the buffered first sensor data from the first volatile memory device, as read first sensor data, in response to the first sensor data being stored in the first volatile memory device;
allocate, to the read first sensor data, a first physical address that is associated with the non-volatile memory device; and
store the first sensor data in a storage area of the non-volatile memory device corresponding to the first physical address.

20. The integrated memory device of claim 17, wherein the integrated controller is further configured to:
receive second sensor data from the host device through the CXL memory interface circuit;
allocate, to the second sensor data, a second physical address that is associated with the non-volatile memory device; and
store the second sensor data in a storage area of the non-volatile memory device corresponding to the second physical address.
